(19) United States
(12) Patent Application Publication
(10) Pub. No.: US 2009/0086215 A1
(43) Pub. Date: Apr. 2, 2009

(54) Polarization-Multiplexed Multilevel Differential Phase Shift Keyed Signal Detector

(76) Inventors: Xiang Liu, Marlboro, NJ (US); Chandrasekhar Sethumadhavan, Old Bridge, NJ (US)

Correspondence Address: WALL & TONG, LLP/;ALCATEL-LUCENT USA INC., 595 SHREWSBURY AVENUE, SHREWSBURY, NJ, 07702, US

(21) Appl. No.: 11/865,035

(22) Filed: Sep. 30, 2007

(51) Int. Cl. G01B 9/02

(52) U.S. Cl. 356/491

(57) ABSTRACT

An apparatus and method for detecting a PMUX multilevel DPSK signal having at least two polarization components with equal symbol periods, which comprises utilizing two polarization-independent Optical Delay Interferometers (ODIs), detecting the four outputs of the two ODIs with two balanced detectors, and digitizing the two detected electronic signals at a sampling rate of twice the symbol rate of the said polarization component signals.

### FIELD OF THE INVENTION

The present invention generally relates to high data rate communications signal detection, and more particularly, an efficient means of detecting a polarization-multiplexed multilevel signal.

### BACKGROUND OF THE INVENTION

As advances in technology require communication systems to facilitate increasingly higher data rates, spectrally efficient modulation methods must be utilized to support them. Polarization-multiplexing is a means of providing an additional layer to an existing modulation scheme, onto which further information can be imparted. Examples of such modulation methods include, but are not limited to, Polarization-Multiplexed Differential Quadrature Phase Shift Keying (PMUX-DQPSK), and Polarization-Multiplexed Differential 8-ary Phase Shift Keying (PMUX-D8PSK). To receive a PMUX signal, polarization demultiplexing is needed. In most of proof-of-concept demonstrations, polarization demultiplexing is performed by a polarization beam splitter (PBS) following a manually adjusted polarization controller. In practical systems, automatic polarization demultiplexing, without any manual intervention, is required. An Optical polarization stabilizer could be used before the PBS to realize polarization demultiplexing, but the cost and complexity associated with the polarization stabilizer are potential deficiencies. As the usefulness of polarization-multiplexing modulation techniques is continually demonstrated, the need for a means of efficiently detecting such PMUX signals becomes apparent.

### SUMMARY OF THE INVENTION

Various deficiencies of the prior art are addressed by an apparatus and method for detecting a Polarization Multiplexed Differential m-ary Phase Shift Keyed (PMUX-DmPSK) signal.

Specifically, an apparatus according to one embodiment of the invention comprises two polarization-independent optical delay interferometers (ODIs), which have substantially the same delay but differ in phase offset by about 90 degrees (or /2), for detecting a PMUX-mDPSK signal having first and second polarization components, outputting a first pair of “in-phase” signals for both the first and second polarization components, and outputting a second pair of “quadrature-phase” signals for both the first and second polarization components; a first balanced detector for receiving the in-phase signals for the first and second polarization components, and providing thereby a first electronic signal; a second balanced detector for receiving the quadrature-phase signals for the first and second polarization components, and providing thereby a second electronic signal; a first digitizer operating at twice the symbol rate of the PMUX-DmPSK signal for receiving the first electronic signal, and providing thereby a first digitized output; a second digitizer operating at twice the symbol rate of the PMUX-DmPSK signal for receiving the second electronic signal, and providing thereby a second digitized output; a first deinterleaver for receiving the first digitized output, and providing thereby separate outputs for the in-phase digital representations for the first and second polarization components; and a second deinterleaver for receiving the second digitized output, and providing thereby separate outputs for the quadrature-phase digital representations for the first and second polarization components.

### BRIEF DESCRIPTION OF THE DRAWINGS

The teachings of the present invention can be readily understood by considering the following detailed description in conjunction with the accompanying drawings, in which:

FIG. 1 depicts a detector for receiving a polarization-multiplexed differential quadrature phase-shift keying (PMUX-DQPSK) signal;

FIG. 2 depicts a detector for receiving a PMUX-DQPSK signal, with further digital signal processing to enhance receiver sensitivity and mitigate transmission impairments such as nonlinear phase noise; and

FIG. 3 depicts a detector for receiving a PMUX-D8PSK signal.

To facilitate understanding, identical reference numerals have been used, where possible, to designate identical elements that are common to the various figures.

### DETAILED DESCRIPTION OF THE INVENTION

The invention will be primarily described within the context of a polarization-multiplexed multilevel differential phase shift keyed signal detector for detecting polarization-multiplexed DQPSK and D8PSK signals, however, those skilled in the art and informed by the teachings herein will realize that the invention is also applicable to detecting other polarization multiplexed differential m-ary phase shift keyed (PMUX-DmPSK) signal types.

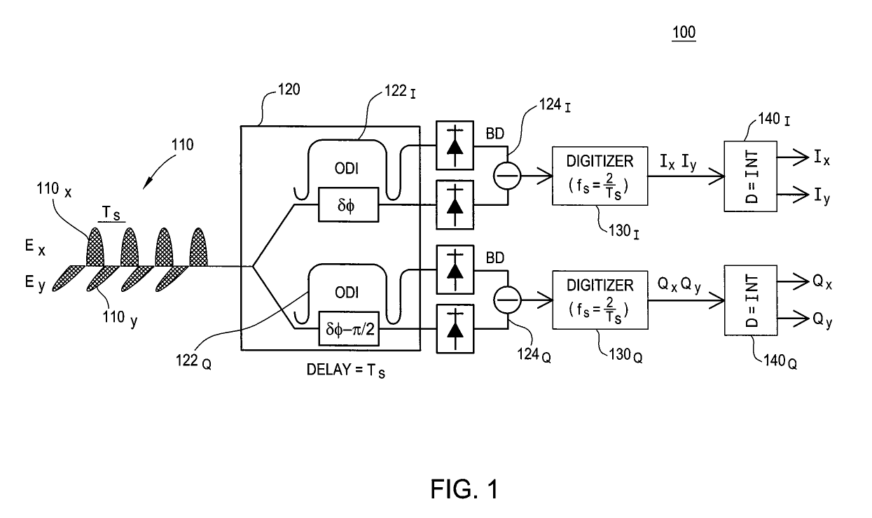

FIG. 1 depicts a detector 100 for receiving a polarization-multiplexed differential quadrature phase-shift keyed PMUX-DQPSK signal 110, per an embodiment of the invention. Modulated upon PMUX-DQPSK signal 110, is pre-coded data from four original “in-phase” (“I”) and “quadrature-phase” (“Q”) data tributaries of two polarization components, Iₓ, I_{y}, Qₓ, and Q_{y}. PMUX-DQPSK signal 110 comprises two polarization components, orthogonally oriented with respect to each other, including, for example, an ‘x’ polarized signal component Eₓ 110ₓ, and a ‘y’ polarized signal component E_{y} 110_{y}. Eₓ 110ₓ, and E_{y} 110_{y} both have an identical symbol period Tₛ. In one embodiment PMUX-DQPSK 110 signal utilizes a return-to-zero (RZ) format, and 110ₓ, and E_{y} 110_{y} are offset in time from each other by substantially Tₛ/2.

PMUX-DQPSK signal 110 is received by polarization independent orthogonal delay interferometer pair (ODIP) circuit 120. Internally, ODIP circuit 120 is depicted as power dividing PMUX-DQPSK signal 110, and comprising two separate branches; namely, OD_{I} 122_{I} for receiving and recovering the ‘I’ components of PMUX-DQPSK signal 110, and ODI_{Q} 122_{Q} for receiving and recovering its ‘Q’ components. ODI_{I} 122_{I} and ODI_{Q} 122_{Q} both have delay paths tuned to a delay value of substantially Tₛ, but differ in phase offset by substantially 90 degrees (or /2). In this manner, the four outputs of ODI circuit 120 correspond to the constructive and destructive interferences of the ‘I’ and ‘Q’ components of PMUX-DQPSK signal 110.

The outputs of ODI_{I} 122_{I} and ODI_{Q} 122_{Q} are fed respectively to the inputs of two balanced detectors 124, and 124_{Q}, which generate corresponding electronic signals. In this embodiment, ODIP circuit 120 and balanced detectors 124_{I} and 124_{Q} collectively comprise a detection stage for detector 100. The outputs of balanced detectors 124_{I} and 124_{Q} are received respectively by a digitizing stage, comprising digitizers 130_{I} and 130_{Q}. Both digitizers 130_{I} and 130_{Q} operate at a sample rate (fₛ) of twice the symbol rate, or 2/Tₛ. Binary digitizer 130, thereby contemporaneously digitizes the ‘I’ portions of both polarization components Eₓ 110ₓ and E_{y} 110_{y} to produce a single binary output, while binary digitizer 130_{Q} does the same for the ‘Q’ portions of both polarization components to produce a single binary output. Following combined-polarization digitization, the two recovered ‘I’ and ‘Q’ binary outputs are passed respectively to two 1:2 electronic demultiplexers, or deinterleavers (D-INTs) 140_{I} and 140_{Q}, which represent a deinterleaving stage to separate the digital binary representation of the ‘I’ data symbols modulated on the ‘x’ polarized component of PMUX-DQPSK signal 110 (Eₓ 110ₓ), from that modulated on the ‘y’ polarized component (E_{y} 110_{y}), and in the same manner, the digital binary representation of the ‘Q’ data symbols modulated on Eₓ 110ₓ, from that on E_{y} 110_{y}.

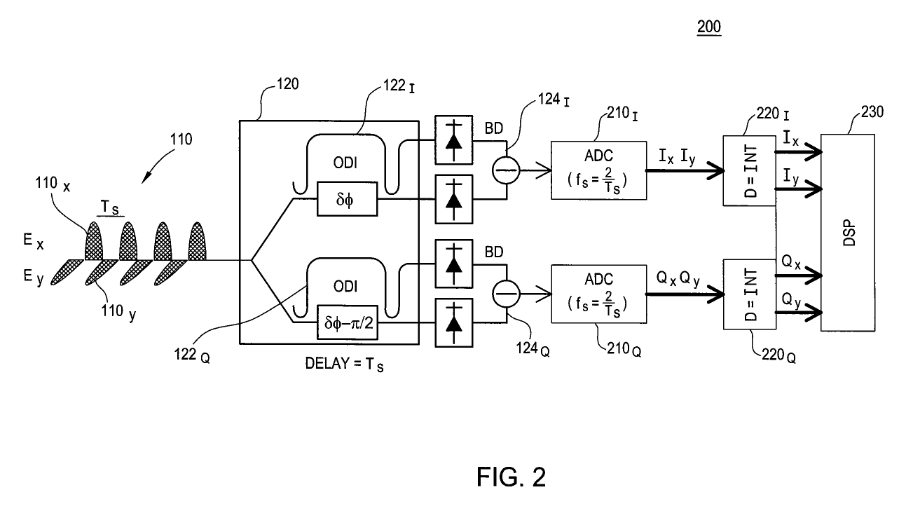

In another embodiment of the invention, shown as detector 200 in FIG. 2, binary digitizers 130_{I} and 130_{Q} are replaced by multilevel analog-to-digital converters (ADCs) 210_{I} and 210_{Q}, each having a sampling rate of two times the symbol rate, 2/Tₛ, and providing a digital multi-level (instead of binary) output, e.g. with a resolution of about 5 bits (or 32 levels). The digital multilevel ‘I’ and ‘Q’ outputs are then passed respectively to D-INT 220_{I} and D-INT 220_{Q}, which like D-INTs 220_{I} and 220_{Q} (of FIG. 1), respectively separate the digital multilevel representation of ‘I’ data symbols modulated on Eₓ 110ₓ from that on E_{y} 110_{y}, and the digital multilevel representation of ‘Q’ data symbols contained on Eₓ 110x, from that on E_{y} 110y, But, D-INTs 220_{I} and 220_{Q} are additionally configured to support the multi-level resolution provided by ADCs 210_{I} and 210_{Q}. The outputs of D-INTs 140_{I} and 140_{Q}, representing the digital multilevel representations of the data from the original four ‘I’ and ‘Q’ data tributaries of two polarization components, Iₓ, I_{y}, Qₓ, and Q_{y}, are passed to a Digital Signal Processor (DSP) 230, configured to enhance the functionality of detector 200, receiver sensitivity and/or mitigate transmission impairments such as nonlinear phase noise, before recovering the original four data tributaries in the binary format. Receiver sensitivity enhancement, as an example, can be achieved through data-aided multi-symbol phase estimation, as described in X. Liu, “Generalized data-aided multi-symbol phase estimation for improving receiver sensitivity in direct-detection optical m-ary DPSK,” Opt. Express, vol. 15, 2927-2939, 2007, incorporated herein by reference in its entirety. Nonlinear phase noise mitigation can be achieved through post nonlinear phase noise compensation similar to that described in K.-P. Ho and J. M. Kahn, “Electronic compensation technique to mitigate nonlinear phase noise,” J. Lightwave Technology, vol. 22, pp. 779-783, 2004, incorporated herein by reference in its entirety.

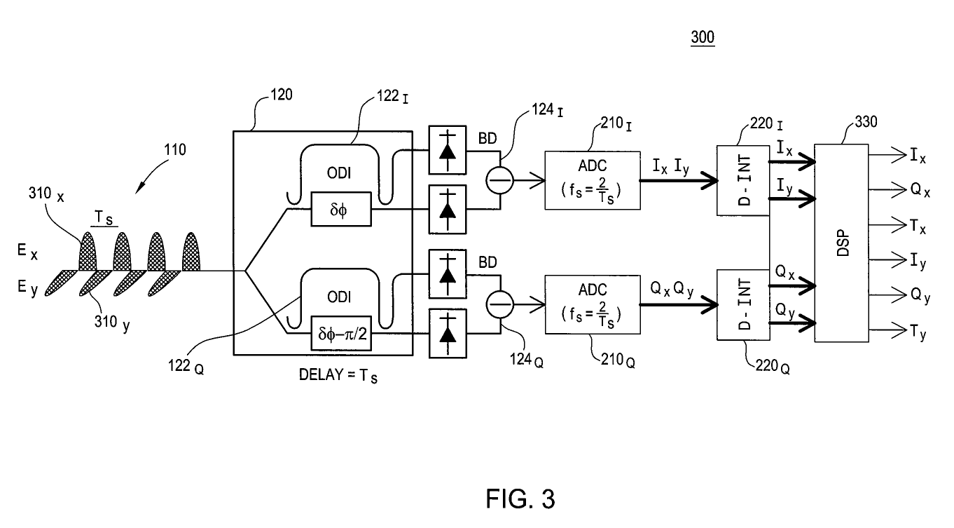

In another embodiment of the invention, shown as detector 300 in FIG. 3, the invention detects PMUX-D8PSK signal 310, generated from six original data tributaries Iₓ, I_{y}, Qₓ, Q_{y}, Tₓ, and T_{y}. PMUX-D8PSK signal 310 comprises two polarization components, orthogonally oriented with respect to each other, including, for example, an ‘x’ polarized signal component Eₓ 310ₓ, and a ‘y’ polarized signal component E_{y} 310_{y}. Eₓ 310ₓ, and E_{y} 310_{y} both have an identical symbol period Tₛ. ADCs 210_{I} and 210_{Q}. each has a sampling rate of two times the symbol rate, 2/Tₛ, and provides a digital multi-level output. The digital multilevel ‘I’ and ‘Q’ outputs are then passed respectively to D-INT 220_{I} and D-INT 220_{Q}, which respectively separate the digital multilevel representation of ‘I’ data symbols modulated on Eₓ 310ₓ from that on E_{y} 310_{y}, and the digital multilevel representation of ‘Q’ data symbols contained on Eₓ 310ₓ, from that on E_{y} 310_{y}. The four outputs of D-INTs 220_{I} and 220_{Q} represent the digital multilevel representations of the data from four of the six original data tributaries of two polarization components, Iₓ, I_{y}, Qₓ, and Q_{y}. The digital multilevel representations of the remaining two original data tributaries, Tₓ and T_{y}, are obtained through signal processing in DSP 330 using the available digital multilevel representations of Iₓ, I_{y}, Qₓ, and Q_{y}, similar to that also described in X. Liu, “Generalized data-aided multi-symbol phase estimation for improving receiver sensitivity in direct-detection optical m-ary DPSK,” Opt. Express, vol. 15, 2927-2939, 2007, previously incorporated by reference. DSP 330 can also optionally perform receiver sensitivity enhancement and/or mitigation of transmission impairments such as nonlinear phase noise. Finally, DSP 330 recovers the original six data tributaries of the PMUX-8DPSK signal in the binary format.

The various processes described above as apparatus functionality may also be construed as a methodology for recovering the in-phase and quadrature-phase components for each polarization of a multi-level polarization-multiplexed DmPSK signal. Thus, for example, one embodiment of the invention comprises contemporaneously detecting in-phase and quadrature-phase components for both polarizations of a polarization-multiplexed DmPSK signal to produce an in-phase components signal and a quadrature-phase components signal; digitizing each of the in-phase and quadrature-phase components signals at a sample rate of at least twice the symbol rate; and deinterleaving the digitized in-phase and quadrature-phase components signals to provide, respectively, the in-phase components for each polarization and the quadrature-phase components for each polarization.

It will be appreciated by those skilled in the art, and informed by the teachings of the present invention, that the invention may be configured to support any PMUX multilevel DPSK modulation formats and additional PMUX modulation formats, beyond those mentioned above. Hence, while the foregoing is directed to various embodiments of the present invention, other and further embodiments of the invention may be devised without departing from the basic scope thereof. As such, the appropriate scope of the invention is to be determined according to the claims, which follow.

What is claimed is:

1. An apparatus for recovering the in-phase and quadrature-phase components for each polarization of a polarization-multiplexed DmPSK signal, comprising:
a detection stage for contemporaneously detecting in-phase and quadrature-phase components for both polarizations of a polarization-multiplexed DmPSK signal to produce an in-phase components signal and a quadrature-phase components signal;
a digitizing stage for digitizing each of the in-phase and quadrature-phase components signals at a sample rate of at least twice the symbol rate; and
a deinterleaving stage for deinterleaving the digitized in-phase and quadrature-phase components signals to provide, respectively, the in-phase components for each polarization and the quadrature-phase components for each polarization.

2. The apparatus of claim 1, wherein the detection stage comprises:
a power divider responsive to said signal, for providing thereby first and second divided signals;
a pair of polarization-independent optical delay interferometers responsive to said first and second divided signals for outputting a pair of in-phase signals for both polarizations, and contemporaneously a pair of quadrature-phase signals for the first and second polarization components;
a first balanced detector for receiving the pair of in-phase signals for both polarizations, and providing thereby a first electronic signal; and
a second balanced detector for receiving the pair of quadrature-phase signals for both polarizations, and providing thereby a second electronic signal.

3. The apparatus of claim 1, wherein the digitizing stage comprises:
a first digitizer operating at twice the symbol rate of the multilevel DPSK signal for receiving the first electronic signal, and providing thereby a first digital output; and
a second digitizer operating at twice the symbol rate of the multilevel DPSK signal for receiving the second electronic signal, and providing thereby a second digital output.

4. The apparatus of claim 1, wherein the deinterleaving stage comprises:
a first deinterleaver for receiving the first digital output, and providing thereby separate digital representations for the in-phase data symbols for both polarizations; and
a second deinterleaver for receiving the second digital output, and providing thereby separate digital representations for the quadrature-phase data symbols for both polarizations.

5. The apparatus of claim 2, wherein the first and second polarization components of the signal are orthogonally polarized with respect to each other.

6. The apparatus of claim 2, wherein the first and second polarization components are offset in time by substantially half the symbol period of the multilevel DPSK signal.

7. The apparatus of claim 2, wherein the first and second polarization components are of return-to-zero format.

8. The apparatus of claim 2, wherein the pair of optical delay interferometers have a delay of substantially the symbol period of the multilevel DPSK signal.

9. The apparatus of claim 2, wherein the two optical delay interferometers differ in phase offset by substantially 90 degrees.

10. The apparatus of claim 1, wherein the first digitizer and the second digitizer are binary decision circuits each providing a digital binary output.

11. An apparatus for detecting a polarization-multiplexed multilevel DPSK signal having first and second polarization components, comprising:
a power divider responsive to said signal, for providing thereby first and second divided signals;
a pair of polarization-independent optical delay interferometers responsive to said first and second divided signals for outputting a pair of in-phase signals for the first and second polarization components, and contemporaneously a pair of quadrature-phase signals for the first and second polarization components;
a first balanced detector for receiving the pair of in-phase signals for the first and second polarization components, and providing thereby a first electronic signal.
a second balanced detector for receiving the pair of quadrature-phase signals for the first and second polarization components, and providing thereby a second electronic signal;
a first digitizer operating at twice the symbol rate of the multilevel DPSK signal for receiving the first electronic signal, and providing thereby a first digital output;
a second digitizer operating at twice the symbol rate of the multilevel DPSK signal for receiving the second electronic signal, and providing thereby a second digital output;
a first deinterleaver for receiving the first digital output, and providing thereby separate digital representations for the in-phase data symbols for the first and second polarization components; and
a second deinterleaver for receiving the second digital output, and providing thereby separate digital representations for the quadrature-phase data symbols for the first and second polarization components.

12. The apparatus of claim 11, wherein the first and second polarization components of the polarization-multiplexed multilevel DPSK signal are orthogonally polarized with respect to each other.

13. The apparatus of claim 11, wherein the first and second polarization components are offset in time by substantially half the symbol period of the multilevel DPSK signal.

14. The apparatus of claim 11, wherein the first and second polarization components are of return-to-zero format.

15. The apparatus of claim 11, wherein the pair of optical delay interferometers have a delay of substantially the symbol period of the multilevel DPSK signal.

16. The apparatus of claim 11, wherein the two optical delay interferometers differ in phase offset by substantially 90 degrees.

17. The apparatus of claim 11, wherein the signal is a polarization-multiplexed D8PSK signal.

18. The apparatus of claim 11, wherein the first digitizer and the second digitizer are binary decision circuits each providing a digital binary output.

19. The apparatus of claim 11, wherein the first digitizer and the second digitizer are analog-to-digital converters each providing a digital multilevel output.

20. The apparatus of claim 19, wherein the resolution of said analog-to-digital converters is substantially 5 bits.

21. The apparatus of claim 19, wherein the first and second deinterleavers are configured to obtain four digital multilevel representations for the in-phase and quadrature-phase data symbols of the first and second polarization components.

22. The apparatus of claim 21, wherein said four digital multilevel representations are received and processed by a digital signal processor to enhance the receiver sensitivity.

23. The apparatus of claim 21, wherein said four digital multilevel representations are received and processed by a digital signal processor to mitigate transmission impairments.

24. The apparatus of claim 21, wherein said four digital multilevel representations are received and processed by a digital signal processor to obtain all original data tributaries of the signal in binary format.

25. A method, comprising:
contemporaneously detecting in-phase and quadrature-phase components for both polarizations of a polarization-multiplexed DmPSK signal to produce an in-phase components signal and a quadrature-phase components signal;
digitizing each of the in-phase and quadrature-phase components signals at a sample rate of at least twice the symbol rate; and
deinterleaving the digitized in-phase and quadrature-phase components signals to provide, respectively, the in-phase components for each polarization and the quadrature-phase components for each polarization.
